(19) United States
(12) Patent Application Publication
(10) Pub. No.: US 2003/0224838 A1
(43) Pub. Date: Dec. 4, 2003

(54) Mask communication system

(76) Inventors: Greg Skillicorn, Glenwillow, OH (US); Joseph Birli, Munson, OH (US); David Potts, Parma Heights, OH (US); Jonathan D. Adams, Shaker Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/198,633

(22) Filed: Jul. 18, 2002

Related U.S. Application Data
(60) Provisional application No. 60/306,346, filed on Jul. 18, 2001.

(51) Int. Cl. H04Q 7/20

(52) U.S. Cl. 455/575.2; 455/575.9

(57) ABSTRACT

A communication system for a mask including an externally mounted microphone and ear speaker assembly is provided. The microphone and ear speaker assembly are adapted for electrical interconnection with a radio. A lapel microphone assembly optionally including a transmission activation device, a microphone, a speaker and an amplifier may be included. An interconnection cable connecting the microphone and ear speaker assembly to a lapel microphone assembly facilitates connection and disconnection between the assemblies.

### FIELD OF THE INVENTION

The present invention relates to communication systems for gas masks or face masks.

### BACKGROUND OF THE INVENTION

Protective gas masks or face masks are well known in the art. These masks provide breathing capabilities while protecting the mask user from noxious gases, smoke, paint fumes, etc. People wearing the masks often have a need to communicate with one another, particularly during emergency situations, and particularly by radio. Accordingly, several voice transmission systems or communication systems have been developed for this purpose.

It is known in the art to provide radio communication equipment on the interior of a protective mask. Such systems, however, can have certain disadvantages. Connectivity between interior communication components and exterior radio components may breach the integrity of the mask or, if integral to the mask, require mask customization. Such customization generally increases the cost of the communication system and often precludes applicability to common masks, such as a firefighter's mask. Many interior components do not fit within many masks. Additionally, many interior components do not function well inside many masks and often inhibit certain functionalities of the mask.

It is also known in the art to provide microphonic equipment on the exterior of a mask. Such exterior equipment can receive a mask wearer's voice without breaching the integrity of the mask. However, such exterior microphones do not transmit auditory signals back to the mask wearer. Under such known systems, a mask wearer must either have an interior speaker connected to the exterior microphone and/or a radio, or rely on the mask wearer's natural hearing for receiving sounds. Such interior speakers suffer from the disadvantages discussed above. The effectiveness of natural hearing is often significantly decreased by the muffling effect of the mask, and further decreased in emergency situations wherein ambient external sounds further muffle desired auditory sounds, such as communication from a fellow mask-wearer.

### SUMMARY OF THE INVENTION

According to one embodiment of the present invention, a communication system for a protective head gear device having an externally mounted microphone and ear speaker assembly adapted for electrical interconnection with a radio is provided. According to another embodiment of the present invention, a communication system for a protective head gear device having an externally mounted microphone, an externally mounted ear speaker and a transmission activation device is provided.

According to another embodiment of the present invention, a protective head gear device having an externally mounted microphone and ear speaker assembly adapted for electrical interconnection with a radio is provided. According to another embodiment of the present invention, a modular communication system for a protective head gear device having an externally mounted microphone and ear speaker assembly, a lapel microphone assembly and an interconnect cable is provided.

According to another embodiment of the present invention, a communication system for a protective head gear device having an externally mounted microphone and a battery-powered amplifier is provided.

An advantage of the present invention is that a wearer of a mask may communicate with others using a communication system which does not physically penetrate the mask. Still further advantages of the current invention will become apparent to those of ordinary skill in the art upon reading and understanding the following detailed description of the preferred embodiments.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of this invention.

FIG. 1 is an exemplary system diagram of a communication system in accordance with one embodiment of the present invention.

FIG. 2 is an exemplary top view of an assembly of a communication system in accordance with one embodiment of the present invention.

FIG. 3 is an exemplary top view of a lapel microphone assembly of a communication system in accordance with one embodiment of the present invention.

FIG. 4 is an exemplary top view of an amplifier of a communication system in accordance with one embodiment of the present invention.

### DETAILED DESCRIPTION OF THE ILLUSTRATED EMBODIMENTS

The following includes definitions of exemplary terms used throughout the disclosure. Both singular and plural forms of all terms fall within each meaning. Except where noted otherwise, capitalized and non-capitalized forms of all terms fall within each meaning:

As used herein, a “protective head gear device” is a mask or a mask in combination with a protective hood, a helmet, any other protective device adapted to be worn over a person's head, or any combination thereof.

As used herein, “mask” is used generically and includes but is not limited to gas masks or protective face masks used by firefighters or other personnel to provide breathing capabilities to the wearer while protecting the wearer from undesirable airborne elements such as noxious gases, smoke, paint fumes or the like.

As used herein, “sound signal” is used generically and includes any electronic representation of a sound, including voice, which is suitable for facilitating communication between communication system components including, but not limited to, a microphone, a speaker, a radio, an amplifier and a transmission activation device.

As used herein, a “transmission activation device” is a push-to-talk device, a voice activation device, or any suitable device for activating at least one sound input device, such as a microphone, and a transmission component of a radio whereby the sound received by the input device may be transmitted by the radio.

As used herein, “push-to-talk device” is used generically and includes but is not limited to any switch which, when pushed or otherwise actuated, facilitates the activation of at least one sound input device and transmission of sound received by such device by a radio.

As used herein, “voice activation device,” is used generically and includes but is not limited to any device which, upon detection of a sound, facilitates the activation of at least one sound input device and transmission of sound received by such device by a radio.

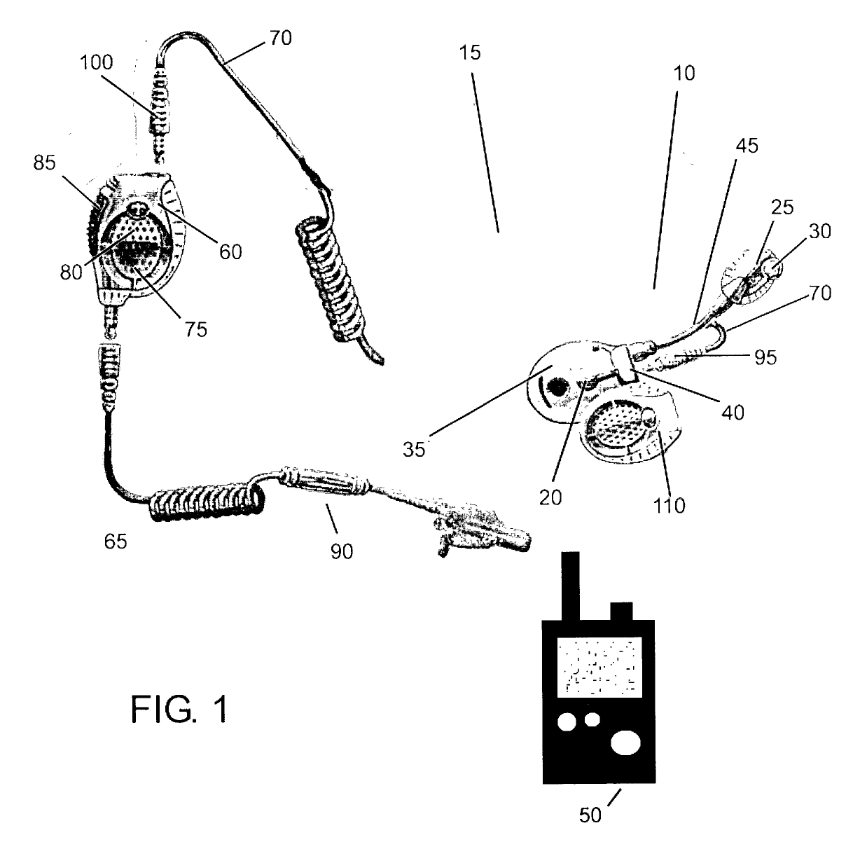

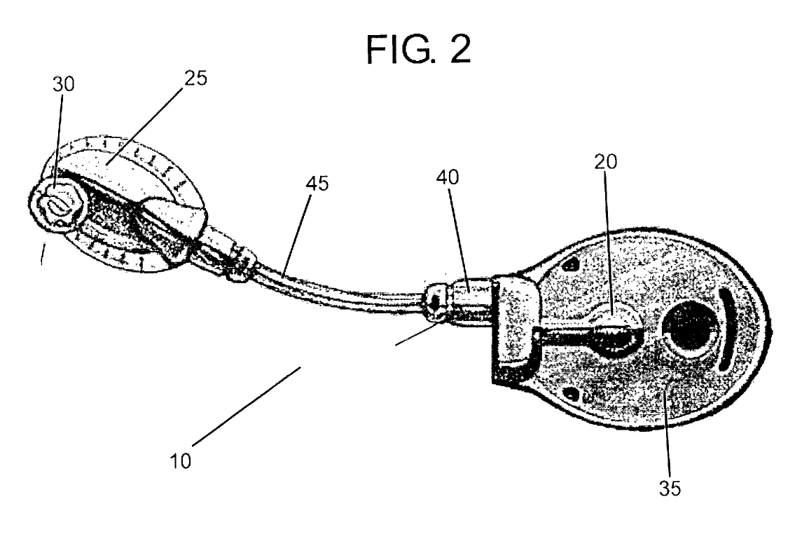

Illustrated in FIGS. 1 and 2 is an exemplary diagram including a mask communication system in accordance with one embodiment of the present invention. Microphone and ear speaker assembly 10 mounts to the exterior of mask 15 to facilitate voice reception from and sound transmission to the wearer of mask 15. While elements of embodiments of the present invention will be described in relation to mounts on the exterior of a mask, it will be understood that such elements may be mounted on the exterior of the mask itself or on the exterior of a protective head gear device of which a mask is a component. Mask 15 is any suitable mask. In an embodiment, mask 15 is one of the exemplary masks as described in U.S. Pat. Nos. 5,138,666, 5,371,804 and 5,428,688, incorporated herein by reference. Mask 15 may have a voice emitter passage, an exemplary embodiment of which is described in U.S. Pat. No. 5,428,688.

Microphone and ear speaker assembly 10 comprises microphone 20 and ear speaker 25. Microphone 20 is adapted for mounting on the exterior of mask 15 without physically penetrating the mask. Microphone 20 is adapted for such mounting in any suitable way, including being shaped so as to fit in a receptacle of the mask, having a clamp capable of physical bonding coupled to the microphone and having adhesive on a side of the microphone facing the mask. Microphone 20 is any suitable microphone capable of receiving spoken words and other noises emitted by the wearer of mask 15 while being mounted externally on mask 15. Exemplary microphones capable of such reception are described in U.S. Pat. Nos. 5,138,666, 5,371,804 and 5,428,688. In an embodiment, microphone 20 is mounted over a voice emitter passage (not shown) of mask 15.

Ear speaker 25 is adapted for mounting on the exterior of mask 15 without physically penetrating the mask. Ear speaker 25 is adapted for such mounting in any suitable way. In embodiments of the present invention wherein components of a protective head gear device which do not comprise the mask cover the wearer's ears, ear speaker 25 is mounted on the exterior of a component of the protective head gear device which covers an ear. Ear speaker 25 includes any suitable speaker capable of ambient transmission of a sound signal communicated to the ear speaker. In an embodiment of the present invention, ear speaker 25 includes volume control 30 for controlling the volume of the speaker's transmission.

In an embodiment of the present invention, microphone and ear speaker assembly 10 includes a microphone body 35 substantially enclosing microphone 20 and adapted for mounting on the exterior of mask 15 without physically penetrating the mask. Microphone body 35 is adapted for such mounting in any suitable way. Microphone body 35 is made of any suitable material, including plastic or metal. In an embodiment of the present invention, microphone body 35 includes interface adaptor 40. Interface adaptor 40 includes electrical connection mechanisms for facilitating electrical interconnection between components of a communication system of the present invention. Interface adaptor 40 includes any suitable electric connection mechanism, including electrically-conductive wire and a printed circuit board. In an embodiment, interface adaptor 40 electrically interconnects microphone 20 with other components of a communication system of the present invention, as described below.

In an embodiment of the present invention, ear speaker 25 is coupled to microphone 20 and microphone body 35 by ear speaker connection cable 45. Connection cable 45 is any suitable connection cable for maintaining a physical connection between ear speaker 25 and microphone body 35. In an embodiment, connection cable 45 is a rigid or semi-rigid and adjustable boom capable of maintaining ear speaker 25 in relative proximity to microphone body 35 and mask 15. In this embodiment, microphone body 35 is physically mounted to the exterior of mask 15 while ear speaker 35 is not physically mounted to the exterior of mask 15, but is instead adapted for mounting on the exterior of mask 15 by virtue of the rigid or semi-rigid nature of connection cable 45. Ear speaker 35 is held in position proximate to the wearer's ear by manipulating the boom so that ear speaker 35 is over the wearer's ear. In another embodiment, connection cable 45 includes an electrical connection, such as an electrically conductive wire, for facilitating electrical interconnection between ear speaker 25 and interface adapter 40.

Referring again to FIG. 1, microphone and ear assembly 10 is adapted for electrical interconnection with radio 50. Radio 50 is any suitable radio capable of sending and receiving radio transmissions translatable into sound signals which are convertible to auditory sounds. Radio 50 is powered by any suitable power source. In an embodiment, radio 50 is battery powered. Sounds received by microphone 20 are electrically communicated by sound signal to radio 50. When received by radio 50, the sound signal is transmitted by radio 50. Sound signals received by radio 50 are electrically communicated to ear speaker 25. When received by ear speaker 25, these sounds are converted to an auditory ambient transmission by ear speaker 25 for reception by an ear of the wearer.

Microphone and ear speaker assembly 10 is electrically interconnected with radio 50 in any suitable way. In one embodiment of the present invention (not shown in FIG. 1), microphone 20 and ear speaker 25 are directly connected to radio 50 by any suitable means, including at least one electrically conductive wire. In another embodiment, microphone 20 and ear speaker 25 are electrically interconnected with interface adapter 40 by any suitable means, and interface adaptor 40 is directly connected to radio 50 by any suitable means, including at least one electrically conductive wire.

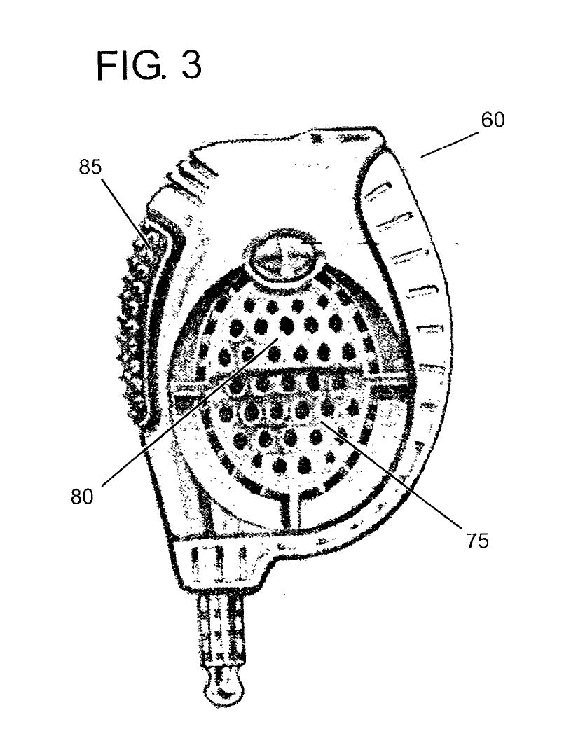

Referring to FIGS. 1 and 3, in another embodiment of the present invention, microphone and ear speaker assembly 10 is electrically interconnected with radio 50 via lapel microphone assembly 60, radio cable 65 and interconnect cable 70. Lapel microphone assembly 60 comprises any suitable electrical connectivity mechanism for facilitating electrical interconnectivity between microphone and ear speaker assembly 10 and radio 50, including electrically conductive wire and a printed circuit board. In an embodiment, lapel microphone 60 is adapted for mounting on the torso or a limb of a mask wearer. In another embodiment, lapel microphone 60 is adapted for mounting on one of the shoulders or the front chest of a mask wearer. Lapel microphone 60 is adapted for such mounting in any suitable way, including having an integral clip for clipping onto the clothing of the wearer.

In an embodiment, lapel microphone assembly 60 includes a microphone 75. Lapel microphone 75 is any suitable microphone capable of receiving spoken words and other noises emitted by or near the wearer of mask 15. Lapel microphone 75 is integral with or electrically interconnected to the electrical connectivity mechanism of lapel microphone assembly 60. In an embodiment, lapel microphone 75 is electrically interconnected with radio 50 whereby sounds received by lapel microphone 75 are communicated to radio 50 for radio transmission by radio 50.

In an embodiment, lapel microphone assembly 60 includes a speaker 80 and optionally an amplifier (not shown). Speaker 80 is any suitable speaker capable of ambient transmission of a sound signal communicated to speaker 80. Speaker 80 is integral with or electrically interconnected to the electrical connectivity mechanism of lapel microphone assembly 60. Optional lapel amplifier is any suitable amplifier capable of amplifying a sound signal for amplified auditory transmission by speaker 80. Lapel amplifier is integral with or electrically interconnected to the electrical connectivity mechanism of lapel microphone assembly 60. Lapel amplifier may be embodied in an amplifier circuit board enclosed in lapel microphone assembly 60. Lapel amplifier may be powered by any suitable power source, including at least one battery.

In an embodiment, speaker 80 is electrically connected to microphone and ear speaker assembly 10 for reception and auditory transmission of sound signals received by microphone 20 and communicated to speaker 80. In an embodiment of the present invention wherein neither the microphone and ear speaker assembly 10 or the lapel microphone assembly 60 is connected to radio 50 or any other power source, optional lapel amplifier may be used to amplify signals received from microphone 20. In this manner, a wearer of mask 15 may have his or her voice communication received by microphone 20 and ambiently transmitted by speaker 80 to those within hearing range of the amplified auditory transmission.

In another embodiment, speaker 80 is electrically interconnected with radio 50 whereby sound signals communicated from radio 50 to speaker 80 are ambiently transmitted. In another embodiment, speaker 80 is electrically interconnected with both microphone and ear speaker assembly 10 and radio 50. In this embodiment, speaker 80 may ambiently transmit sound signals received from both microphone 20 and radio 50.

In an embodiment, lapel microphone assembly 60 includes a transmission activation device 85. In an embodiment wherein the transmission activation device 85 is a push-to-talk device, push-to-talk device 85 is any suitable speaker push-to-talk device capable activating at least one microphone of a communication system of the present invention and further capable of actuating transmission capabilities of radio 50 for radio transmission of any sound received by any activated microphone. In an embodiment, push-to-talk device 85 is electrically interconnected to the electrical connectivity mechanism of lapel microphone assembly 60 and located on an exterior face of lapel microphone assembly 60, whereby the activating device of the push-to-talk device, including a button, may be easily pressed or otherwise actuated by wearer of mask 15. While this embodiment of the present invention has been described with reference to a push-to-talk device integral with lapel microphone assembly 60, it will be understood that a push-to-talk device of a communication system of the present invention may be located in any suitable place and electrically interconnected with the communication system in any suitable manner. For example, a finger push-to-talk device may be coupled to the lapel microphone assembly 60 with a wire and actuated by engaging a pressure device located proximate to a wearer's finger. While these embodiments of the present invention have been described with reference to a transmission activation device which is a push-to-talk device, it will be understood that a transmission activation device of a communication system of the present invention may be any suitable transmission activation device electrically interconnected with the communication system in any suitable manner. For example, a voice activated actuator may be used to activate receipt of sound and transmission thereof by the radio 50. Such a voice activated actuator may be placed in any suitable location for voice activation, including integral with, coupled with or connected to microphone and ear speaker assembly 10. While the remainder of the embodiments described herein will be described in reference to a push-to-talk device integral with lapel microphone assembly 60, it will be appreciated that any suitable transmission activation device may be used.

In an embodiment of the present invention wherein the lapel microphone assembly includes a push-to-talk device and a microphone, both electrically interconnected with microphone and ear speaker assembly 10, the communication system may be configured whereby activation of the push-to-talk device 85 activates either of the lapel microphone 75 and microphone 20. A radio 50 electrically interconnected to such a communication system thus transmits sounds received from which ever microphone is active while the push-to-talk device 85 is activated. Alternatively, activation of the lapel microphone 75 can be configured to depend upon the nature of the electrical interconnection between the lapel microphone assembly 60 and the microphone and ear speaker assembly 10.

For example, if no electrical connection exists between the lapel microphone assembly 60 and the microphone and ear speaker assembly 10, then the communication system may be configured so that the lapel microphone is activated to receive auditory sounds. Under this configuration, since microphone 20 is not electrically connected to the communication system, only auditory sounds received by lapel microphone 75 may be communicated to radio 50 for radio transmission. Such a configuration allows a user to remove mask 15, electrically disconnect the microphone and ear speaker assembly 10 from the communication system, and use the lapel microphone assembly as a remote radio microphone and push-to-talk device. Under another example, if an electrical connection exists between the lapel microphone assembly 60 and the microphone and ear speaker assembly 10, then the communication system may be configured so that the lapel microphone 75 is deactivated and microphone 20 is activated and receiving auditory signals. Such a configuration allows a wearer of the mask 15 to only have his or her voice, as received by microphone 20, communicated to radio 50 for radio transmission, rather than his or her voice as received by microphone 20 and other ambient sounds as received by lapel microphone 75 were lapel microphone 75 to be activated.

In an embodiment, a communication system of the present invention is configured so that when an electrical connection exists between the lapel microphone assembly 60 and the microphone and ear speaker assembly 10, the lapel microphone 75 is deactivated and microphone 20 is activated whenever the push-to-talk device 85 is activated. This exemplary system is further configured so that when an electrical connection does not exist between the two assemblies, no sound signals are received from microphone 20 and lapel microphone 75 is activated whenever the push-to-talk device 85 is activated. Under this exemplary system, a user wearing the mask may communicate via radio 50 via microphone and ear speaker assembly 10 without interference from auditory reception from the lapel microphone system 60, while such a user after taking off the mask may communicate via radio 50 via the lapel microphone system 60 without needing to retain the mask in close proximity to the wearer's head.

Radio cable 65 is any suitable cable capable of electrically connecting radio 50 to lapel microphone assembly 60. In embodiments of the present invention wherein lapel microphone assembly 60 includes a push-to-talk device 85 and optionally a microphone 75 and a speaker 80, radio cable 65 is a suitable cable capable of electrically connecting radio 50 to a push-to-talk device with or without a microphone or speaker. Radio cable 65 may include circuitry 90 for facilitating electronic interconnectivity between lapel microphone assembly 60 and radio 50.

Interconnect cable 70 is any suitable cable capable of electrically connecting lapel microphone assembly 60 to microphone and ear speaker assembly 10. In an embodiment of the present invention, interconnect cable 70 includes a first connector 95 removably connectable to microphone and ear speaker assembly 10 and a second connector 100 removably connectable to lapel microphone assembly 60. Optionally, first connector 95 is removably connectable to interface adaptor 40. The first and second connectors 95 and 100 are any suitable electrical connector capable of being removably connected to a receptacle in the component with which such connectors connect. In an embodiment, such connectors are “quick connect/disconnect” connectors which facilitate quick coupling and uncoupling of interconnect cable 70 with microphone and ear speaker assembly 10 and lapel microphone assembly 60. In such an embodiment, such connectors allow a mask wearer to conveniently disconnect and reconnect the mask 15 to the communication system to facilitate taking the mask 15 on and off.

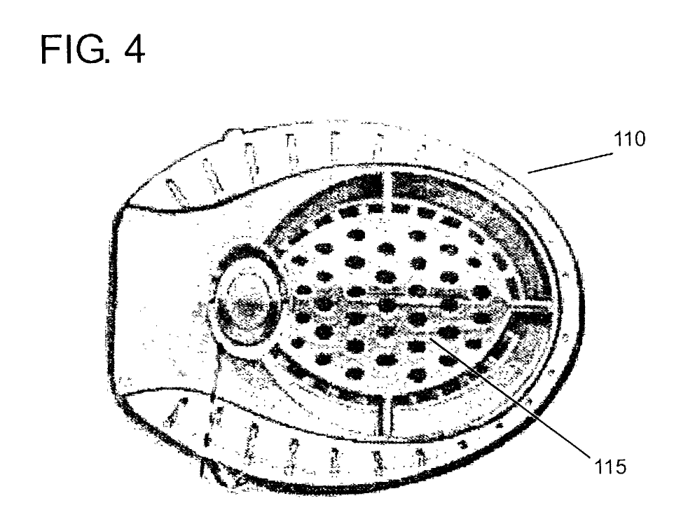

Referring to FIGS. 1 and 4, in another embodiment of the present invention, amplifier 110 having a speaker 115 is electronically connected to microphone 20 for amplified and auditory transmission of sounds received by microphone 20. Amplifier 110 is any suitable amplifier capable of amplifying a sound signal for amplified auditory transmission by speaker 115. Amplifier 110 may be powered by any suitable power source, including at least one battery. Amplifier 110 may be electrically interconnected with microphone 20 in any suitable manner, including physical connection by an electrically-conductive wire. Amplifier 110 may be located in any suitable position on or around wearer of mask 15. In an embodiment, amplifier 110 is mounted on microphone body 35. In another embodiment (not shown), amplifier 110 is integral with microphone 20, microphone body 35, speaker 115 and interface adaptor 40.

While the present invention has been illustrated by the description of embodiments thereof, and while the embodiments have been described in considerable detail, the scope of the appended claims should not be restricted or in any way limited to such detail. Additional advantages and modifications will readily appear to those skilled in the art. Therefore, the invention, in its broader aspects, is not limited to the specific details, the representative systems, and illustrative examples shown and described. Accordingly, departures may be made from such details without departing from the spirit or scope of the invention disclosed herein.

What is claimed is:

1. An externally-mounted communication system for a protective head gear device worn by a person, comprising:
a microphone and ear speaker assembly adapted for mounting on the exterior of the protective head gear device, the assembly including a microphone for receiving the person's voice and an ear speaker for transmitting sound to the person's ear, and the assembly adapted for electrical interconnection with a radio whereby the microphone communicates at least one sound signal to the radio and the ear speaker receives at least one sound signal from the radio.

2. The communication system of claim 1, further comprising:
a transmission activation device electrically connected to the assembly and adapted for electrical interconnection with the radio.

3. The communication system of claim 3 wherein the transmission activation system is a push-to-talk device.

4. The communication system of claim 1, further comprising:
a lapel microphone assembly substantially enclosing a second microphone electrically connected to the microphone and ear speaker assembly and adapted for electrical interconnection with the radio, the lapel microphone assembly adapted for mounting on the exterior torso or a limb of the person.

5. The communication system of claim 4, the lapel microphone assembly further comprising an amplifier and a speaker, the amplifier and speaker adapted for electrical interconnection with the radio whereby a sound signal received by the radio is communicated to the speaker.

6. The communication system of claim 5 wherein the amplifier and speaker are further adapted for electrical interconnection with microphone of the microphone and ear speaker assembly whereby a sound signal received by the microphone is communicated to the amplifier and speaker.

7. The communication system of claim 4, the lapel microphone assembly further comprising a transmission activation device electrically connected to the microphone and ear speaker assembly and the second microphone and adapted for electrical interconnection with the radio.

8. The communication system of claim 7 wherein the transmission activation device is a push-to-talk device.

9. The communication system of claim 7 wherein:
the electronic connection between the microphone and ear speaker assembly and the lapel microphone assembly includes an interconnect cable having a first connector at an end removably connectable to the microphone and ear speaker assembly and a second connector at the other end removably connectable to lapel microphone assembly; and
the communication system is switchable by the person between a first configuration and a second configuration,
the first configuration defined by the microphone and ear speaker assembly being electrically connected to the lapel microphone assembly by the interconnect cable, wherein the microphone of the microphone and ear speaker assembly microphone is activated to receive sound and the lapel microphone is inactive,
the second configuration defined by the microphone and ear speaker assembly not being electrically connected to the lapel microphone assembly by the interconnect cable, wherein the lapel microphone is activated to receive sound and the microphone of the microphone and ear speaker assembly is inactive.

10. The communication system of claim 1, further comprising a microphone body substantially enclosing the microphone and adapted for mounting on the exterior of the protective head gear device.

11. The communication system of claim 10, wherein the microphone body includes an interface adaptor adapted to receive an interconnect cable adapted to electronically interconnect with a radio, the interface adaptor electronically connected to the microphone and the ear speaker.

12. The communication system of claim 10, wherein the electronic connection between the interface adaptor and the ear speaker includes a cable having a connector at one end removably connectible to the interface adaptor.

13. The communication system of claim 1, further comprising:
a battery-powered amplifier for amplifying the person's voice, the amplifier electrically interconnected with at least the microphone.

14. The communication system of claim 13, further comprising:
a microphone body substantially enclosing the microphone and adapted for mounting on the exterior of the protective head gear device, the microphone body adapted for receiving the amplifier and the amplifier adapted for mounting on the microphone body.

15. An externally-mounted communication system for a protective head gear device having a voice emitter passage, the communication system comprising:
a microphone for receiving the person's voice, the microphone adapted for mounting on the exterior of the protective head gear device over the voice emitter passage and for receiving the person's voice without physically penetrating the mask,
an ear speaker for transmitting sound to the person's ear, the ear speaker adapted for mounting on the exterior of the protective head gear device without physically penetrating the head gear device and further adapted for electrical interconnection with a radio whereby the ear speaker receives at least one sound signal from the radio;
a transmission activation device electrically connected to the microphone and adapted for electrical connection with a radio whereby the microphone is capable of communicating at least one sound signal to the radio; and
wherein the communication system is switchable by the person between a first configuration and a second configuration,
the first configuration defined by the transmission activation device being activated, wherein the microphone is activated for reception of sound and such sound is communicated to the radio for transmission, and
the second configuration defined by the transmission activation device not being activated, wherein the microphone is not activated and no sound is communicated to the radio for transmission.

16. The communication system of claim 16, further including:
a battery-powered radio for receiving and transmitting at least one sound signal, the radio electronically interconnected to the ear speaker for communicating sound signals to the ear speaker and electronically interconnected to the microphone and transmission activation device for receiving sound signals received by the microphone.

17. A protective head gear device worn by a person, comprising:
a protective mask; and
a microphone and ear speaker assembly mounted on the exterior of the mask without physically penetrating the mask, the assembly including a microphone for receiving the person's voice and an ear speaker for transmitting sound to the person's ear, the assembly adapted for electrical interconnection with a radio whereby the microphone communicates at least one sound signal to the radio and the ear speaker receives at least one sound signal from the radio.

18. An externally-mounted modular communication system for use with or without a protective head gear device worn by a person, comprising:
(a) a microphone and ear speaker assembly adapted for mounting on the exterior of the protective head gear device, the microphone and ear speaker assembly including a microphone for receiving the person's voice and an ear speaker for transmitting sound to the person's ear;
(b) a lapel microphone assembly substantially enclosing a second microphone and having a transmission activation device, the lapel microphone assembly adapted for mounting on the exterior torso or a limb of the person;
(c) an interconnect cable having a first connector at an end removably connectable to the microphone and ear speaker assembly and a second connector at the other end removably connectable to lapel microphone assembly; and
(d) wherein the communication system is switchable by the person between a first configuration and a second configuration, the first configuration defined by the microphone and ear speaker assembly being electrically connected to the lapel microphone assembly by the interconnect cable, wherein the microphone of the microphone and ear speaker assembly microphone is activated to receive sound and the lapel microphone is inactive, the second configuration defined by the microphone and ear speaker assembly not being electrically connected to the lapel microphone assembly by the interconnect cable, wherein the lapel microphone is activated to receive sound and the microphone of the microphone and ear speaker assembly is inactive.

19. An externally-mounted communication system for a protective head gear device worn by a person, comprising:
a microphone for receiving the person's voice adapted for mounting on the exterior of the protective head gear device; and
a battery-powered amplifier for amplifying the person's voice adapted for mounting exterior to the protective head gear device, the amplifier having a speaker for auditory transmission of the person's voice, and the amplifier electrically interconnected with at least the microphone and the speaker.

20. The communication system of claim 19 further comprising:
a microphone body substantially enclosing the microphone and adapted for receiving the amplifier and for mounting on the exterior of the protective head gear device.

21. The communication system of claim 19 wherein the amplifier is mounted on the torso or limb of the person.
